(19) United States
(12) Patent Application Publication
(10) Pub. No.: US 2004/0153307 A1
(43) Pub. Date: Aug. 5, 2004

(54) Discriminative feature selection for data sequences

(76) Inventors: Naftali Tishby, Jerusalem (IL); Noam Slonim, Princeton, NJ (US); Shai Fine, Raanana (IL)

Correspondence Address: Anthony Castorina, G E Ehrlich, Suite 207, 2001Jefferson Davis Highway, Arlington, VA, 22202, US

(21) Appl. No.: 10/471,757

(22) PCT Filed: Apr. 4, 2002
(86) PCT No.: PCT/IL02/00279

(51) Int. Cl. G06F 17/28

(52) U.S. Cl. 704/4

(57) ABSTRACT

A discriminative feature selection method for selecting a set of features from a set of training data sequences is described. The training data sequences are generated by at least two data sources, and each data sequence consists of a sequence of data symbols taken from an alphabet. The method is performed by first building a suffix tree from the training data. The suffix tree contains only suffixes of the data sequences having an empirical probability of occurrence greater than a first predetermined threshold, from at least one of the sources. Next the suffix tree is pruned of all suffixes for which there exists in the suffix tree a shorter suffix having equivalent predictive capability, for all of the data sources.

### FIELD OF THE INVENTION

The present invention relates to discriminative feature selection for data sequences and more particularly but not exclusively to discriminative feature selection for data sequences originating from multiple data sources.

### BACKGROUND OF THE INVENTION

Feature selection is one of the most fundamental problems in pattern recognition and machine learning. In this approach, one wishes to sort all possible features (i.e. measurable statistics) in the training data using some predefined selection criteria and select only the “best” features for the task at hand. In the context of supervised learning many of the features are usually irrelevant for the identity of the target concept in a given concept class. It thus may be possible to significantly reduce the feature dimensionality without impeding the performance of the learning algorithm. In some cases one might even improve the generalization performance by filtering irrelevant features (cf.[1]). Estimating the joint distribution of the classes and the feature vectors, when either the dimensionality of the feature space or the number of classes is very large, requires impractically large training size. Thus, increasing the number of features, while keeping the sample size fixed, can actually decrease the accuracy of the trained classifier [9, 5] due to estimation errors. Therefore, in many learning problems it is essential to identify the features that are most relevant for the learning process.

The use of MI for feature selection is well known in the machine learning realm. The original idea could probably be traced back to Lewis [12]. Since then a number of methods have been posed, differ essentially in their approximation of the joint and marginal distributions, and usage of the MI measure.

A selection criterion, similar to the one we propose here, was suggested by Goodman and Smyth for decision tree design [8]. The basic principle of their approach involves choosing the “best” feature at any node in the tree, conditioned on the features previously chosen, and the outcome of evaluating those features. Thus, they suggested a top-down algorithm based on greedy selection of most informative features. When all features are a-priori known the decision tree design algorithm selects the most relevant features for the classification task and ignores irrelevant ones. The tree itself yields valuable information on the relative importance of the various features. Another closely related usage of MI for stochastic modeling is the Maximal Mutual Information (MMI) approach for multi-class model training. This is a discriminative training approach attributed to Bahl et al. [3], designed to directly approximate the posterior probability distribution, in contrast to the indirect Bayesian approach. The MMI method was applied successfully to HMM training in speech applications (see e.g.[17]). However, MMI training is significantly more expensive than maximum likelihood (ML) training.

Feature selection can also provide additional insight about the data. Consider for example the problem of classification of protein sequences into families (see e.g. [4]). While it is important to automatically classify the protein sequences into their families it is also interesting to identify the features in the sequence that affect the classification. This can enable the understanding of the biological function of specific subsequences in the protein family.

Another biological application for feature selection methods is locating transcription factors binding sites in upstream regions

Transcription of genes is regulated through proteins, collectively known as “transcription factors”. These proteins bind to specific locations in some vicinity of the gene, whose expression they regulate, and facilitate, or repress, its expression. Identifying the locations to which these proteins bind, “binding sites”, remains a difficult problem in molecular biology, albeit much work in this direction.

There are several reasons for this difficulty. In many organisms, binding sites may appear quite far from the coding region, within the coding regions (inside introns), or on the complementary strand. A single gene might be (and usually is) regulated by several factors, or have several binding sites for the same transcription factor. A single transcription factor might bind to regions which vary greatly in their sequence, and the same binding site might be targeted by more than one protein.

One way to tackle this problem is through biological experiments, which are often costly and time consuming. In essence, these are trial and error experiments, that test how changes in the sequence affect binding of known transcription factors. Other experiments record directly the expression of a reporter gene. In all these trials, at least two additional factors complicate the identification of ‘a real’ binding site. One concern is the role of DNA and chromatin structure in vivo and the other is the joint effect of multiple binding sites. In recent years there has also been much computational work in this field. For the most part, this work is targeted at organisms in which the general location where binding sites reside is known. For example, in yeast, a favorite target for such studies, and for this work as well, almost all known binding sites are located between the translation start codon, and up to 600 bases upstream.

The computational approach aims at finding consensus patterns within these sequences. The underlying thought is that binding sites for a particular transcription factor share some common pattern. For example, this pattern might be TCANNNNNNACG, describing a 12 characters long sequence that starts with TCA, ends with ACG, and may have any 6 characters in between. Since these sequences are far from conserved, finding them is a difficult task.

The general notion that guides this approach, and to some extent this work as well, is that such patterns will appear more frequently in upstream sequences than would be expected at random. One might even pose this as a purely computational problem, as done in [28]. The input is a set of long strings of random characters, and within each, a substring matching a particular pattern is hidden at a random location. The objective is to find the pattern.

Some algorithms (e.g. [24]) that address this problem try to find an optimal multiple (local) alignment of the sequences where the binding sites are sought. Once the sequences are aligned, a consensus matrix is built from the aligned positions, and is thought to be the pattern of the binding site. There are several problems with this approach, such as what to do when the binding site appears in only some of the sequences, or how to locate multiple appearances of the same site. Another approach is to compare the frequency of subsequences within the data, to what is expected by a random model. For example, this might be a k-order Markov model, based on the frequency of k-tuples within the data (or the entire genome). Subsequences, or patterns, which appear significantly more frequently than is expected by the random model, are then thought to be binding sites. There are both statistical (e.g. [29], [19]) and combinatorial ([28]) methods for formally defining what the task is, and for finding such subsequences. The algorithm described herein is close to this latter approach, but differs from previous works known to us, in the way we formulate the problem. Rather than look for a pattern that is common in the data, and might be a binding site, we look for indications that a binding site is at some specific location in the genome.

A number of algorithms currently exist for finding a consensus pattern within a set of long DNA sequences. MEME ([18]), employs an EM technique for building the consensus, from sequences in which the pattern may appear several times or even not at all. Gibbs samplers ([25]) uses Gibbs sampling, a procedure analogous to EM, for finding a re-occuring consensus pattern. Its position in each sequence is first guessed at, and then is iteratively updated for each sequence, according to the pattern generated from the other sequences. CONSENSUS ([24]) looks for a multiple alignment of the sequences, and evaluating its statistical significance. WINNOWER ([28]) builds a graph of all subsequences of a given length, with edges between vertices corresponding to similar sequences, and looks for large cliques in the graph. Other methods make use of neural networks ([33]) or of structural information about the complex that the regulatory protein (for which we look for binding sites) forms with the DNA strand (26). In most of these cases, one looks for the binding site of a particular transcription factor, and in all of them one looks for the entire binding site.

The following documents are referred to herein:

[1] H. Almuallim and T. G. Dietterich. Learning with many irrelevant features. In Proc. of the 9th Natl. Conf. on AI (AAAI-91), 1991.

[2] T. K. Attwood, M. D. Croning, D. R. Flower, A. P. Lewis, J. E Mabey, P. Scordis, J. N. Selley, and W. Wright. PRINTS-S: the database formerly known as PRINTS. Nucleic Acids Res. 2000 Jan. 1; 28(1): 225-7.

[3] L. R. Bahl, P. F. Brown, P. V. de Souza and R. L. Mercer. Maximum Mutual Information Estimation of Hidden Markov Model Parameters for Speech Recognition in Proc. of IEEE Int'l Conf. Acous, Speech & Sig. Processing (ICASSP-86)., Tokyo, Japan, 1986.

[4] G. Bejerano and G. Yona. Modeling protein families using probabilistic suffix trees. In Proc. of RECOMB '99, 1999.

[5] E. B. Baum and D. Haussler. What Size Net Gives Valid Generalization? Neural Computation, 1(1):151-160, 1989.

[6] Y. Bilu, N. Slonim, M. Linial and N. Tishby. Predicting Transcription Factor Binding Sites in Gene-Upstream Regions using a Discriminative VMM model. In preparation.

[7] T. M. Cover and J. A. Thomas. Elements of Information Theory. John Wiley & Sons, New York, 1991.

[8] R. M. Goodman and P. Smyth. Decision Tree Design from Communication Theory Stand Point. IEEE Trans. on IT, 34(5):979-994, 1988.

[9] G. F. Hughes. On the Mean Accuracy of Statistical Pattern Recognizers. IEEE Trans. on IT, 14:55-63, 1968.

[10] T. Joachims. A Probabilistic Analysis of the Rocchio Algorithm with TFIDF for Text Categorization. In Proc. of ICML, 1997.

[11] K. Lang. Learning to filter netnews. In Proc. of ICML, 1995.

[12] P. M. Lewis. The Characteristic Selection Problem in Recognition Systems. IRE Trans. on IT, 8:171-178, 1962.

[13] F. Pereira, Y. Singer and N. Tishby. Beyond Word N-grams. In Natural Language Processing Using Very Large Corpora K. Church, S. Armstrong, P. Isabele, E. Tzoukermann and D. Yarowsky (Eds.), Kluwer Academic Publishers.

[14] D. Ron, Y. Singer and N. Tishby. The Power of Amnesia: Learning Probabilistic Automata with Variable Memory Length. Machine Learning, 25:237-262 (1997).

[15] N. Slonim and N. Tishby. Document Clustering Using Word Clusters via the Information Bottleneck Method. In ACM SIGIR 2000, pp. 208-215, 2000.

[16] N. Slonim and N. Tishby. The Power of Word Clusters for Text Classification. Submitted to ECIR 2001.

[17] P. C Woodland and D. Povey. Large Scale Discriminative Training for Speech Recognition in Proc. of Int. Workshop on Automatic Speech Recognition (ASR-2000), Paris, France, 2000.

[18] T. Bailey and C. Elkan. Unsupervised learning of multiple motifs in biopolymers using expectation maximization. Mahine Learning, 21:51-80, 1995.

[19] H. J. Bussemaker, H. Li and E. D. Siggia. Building a dictionary for genomes: identification of presumptive regulatory sites by statistical analysis. PNAS 97:10096-10100, 2000.

[20] T. M. Cover and J. A. Thomas. Elements of Information Theory. John Wiley & Sons, New York, 1991.

[21] J. M. Cherry et al. Saccharomyces Genome Database ftp://genome-ftp.stanford.edu/pub/yeast/SacchDB/,2000.

[22] M. B. Eisen, P. T. Spellman, P. O. Brown, and D. Botstein, Cluster analysis and display of genome-wide expression patterns. PNAS 95:14863-14868, 1998.

[23] S. R. Eberhardy, C. A. D'Cunha and P. J. Farnham. Direct Examination of Histone Acetylation on Myc Target Genes Using Chromatin Immunoprecipitation. J. Biol. Chem., Vol.275:33798-33805, 2000.

[24] G. Hertz and G. Stormo, Identifying DNA and protein patterns with statistically significant alignments of multiple sequences. Bioinformatics 15:563-577, 1999.

[25] C. Lawrence et al. Detecting subtle sequence signals: A Gibbs sampling strategy for multiple alignment. Science 262:208-214, 1993.

[26] Y. Mandel-Gutfreund, A. Baron and H. Margalit. A Structure-Based Approach for Prediction of Protein Binding Sites in Gene Upstream Regions. Pacific Symposium on Biocomputing 5:464475, 2000.

[27] Quandt et al. MatInd and MatInspector: New, fast and versatile tools for detection of consensus matches in nucleotide sequence data. Nucleic Acids Research 23:4878-4884, 1995.

[28] P. A. Pevzner and S. H. Sze. Combinatorial algorithm for finding subtle signals in DNA sequences. Eighth International Conference on Intelligent Systems for Molecular Biology (ISMB 2000):269-278.

[29] A Statistical Method for Finding Transcription Factor Binding Sites. Eighth International Conference on Intelligent Systems for Molecular Biology (ISMB 2000): 344-354.

[30] N. Slonim, S. Fine and N. Tishby, Discriminative Variable Memory Markov Model for Feature Selection. Submitted to ICML, 2001.

[31] P. T. Spellman et al. Comprehensive Identification of Cell Cycle-regulated Genes of the Yeast Saccharomyces cerevisiae by Microarray Hybridization. MBC 9:3273-3297, 1998.

[32] N. Tishby and N. Slonim. Data Clustering by Markovian Relaxation and the Information Bottleneck Method in Advances in Neural Information Processing Systems (NIPS) 13, to appear.

[33] C. T. Workman and G. D. Stormo, ANN-Spec: A Method for Discovering Transcription Factor Binding Sites with Improved Specificity, Pacific Symposium on Biocomputing, 5:464-475, 2000.

[34] E. Wingender et al. TRANSFAC: an integrated system for gene expression regulation. Nucleic Acids Research, 28:316-319, 2000.

[35] J. Zhu and M. Q. Zhang. SCPD: A promoter database of yeast saccharomyces cerevisiae. Bioinformatics, 15:607-611, 1999. Contents of these documents are hereby incorporated by reference.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows pseudo-code for the GVMM algorithm.

FIG. 2 shows pseudo-code for the DVMM algorithm.

FIG. 3 is a simplified flowchart of a method for selecting a set of features from training data.

FIG. 4 is a simplified flowchart of a method for building a suffix tree.

FIG. 5 is a simplified flowchart of a method for pruning a suffix tree.

FIG. 6 is a simplified block diagram of a discriminative feature selector.

FIG. 7 shows an example of a feature selection problem.

FIG. 8 shows pseudo-code for the VMM algorithm for detecting strong indicators of source c₁.

FIG. 9 shows an example of a nucleotide sequence feature selection problem.

FIG. 10 shows results for text classification.

FIG. 11 shows dataset details for a protein classification task.

FIG. 12 shows the top five features selected for the protein classification task.

FIG. 13 shows clustering results generated from gene expression data.

FIG. 14 shows scores and location of binding sites, for four upstream sequences.

FIG. 15 shows ROC results for 30 difference amounts of characters marked as binding sites.

### DESCRIPTION OF THE PREFERRED EMBODIMENTS

Feature selection is an important component of parameter estimation and machine learning tasks. Properly selected features reduce the dimensionality of the problem, and thus simplify the estimation or learning process. In many cases, without feature selection the problem is not solvable due to an impractically large data size. Feature selection may also offer insights about the data and significant aspects of the data, thereby leading to more effective estimation and learning methodology.

We propose a novel feature selection method, based on a variable memory Markov model (VMM). The VMM was originally proposed as a generative model for language and handwriting [14], trying to preserve the original source statistics from training data. Here we consider the VMM models for extracting discriminative statistics for hypotheses testing. In this context one is provided training data for different sources and the goal is to build a model that preserves the most discriminative features between the sources. We show that a new criterion should be used for pruning the non-discriminative features and propose a new algorithm for achieving that. We demonstrate the new method on text and protein classification and show the validity and power of the method.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Multiclass Generative VMM Model

Consider the classification problem into several different categories denoted by C={c₁, c₂, . . . , c_{|C|}}. The training data consists of a set of labeled samples for each class. Each sample is a sequence of symbols over some alphabet Σ. In a Bayesian learning framework, given some new (test) sample, dεΣ*, our goal is to estimate:

$$P ( c \vert d ) = \frac{P ( d \vert c ) P ( c )}{P ( d )} ∀ c ∈ C , \qquad ( 1 )$$

where P(c) is the prior for each category and P(d) is the unconditional prior of the new sample. Given these estimates, we can classify the new sample by the most probable class. Since by definition, P(d) is independent of C, we can focus on estimating:

P(c|d)∝P(d|c)P(c)∀cεC. (2)

Assuming that we have a good estimate for P(c), we may not concentrate on estimating P(d|c). Let d=σ₁σ₂, . . . σ_{|d|}, σᵢεΣ, then with no approximation we know that in general:

$$P ( d \vert c ) = {\prod }_{i = 1}^{\vert d \vert} P ( {σ}_{i} \vert {σ}_{1} {σ}_{2} … {σ}_{i - 1} , c ) = {\prod }_{i = 1}^{\vert d \vert} P ( {σ}_{i} \vert {s}_{i} , c ) \qquad ( 3 )$$

where we used the notation sᵢεΣⁱ⁻¹ to denote the subsequence of symbols preceding to σᵢ. Denoting by suff(s) the longest suffix of s (different from s) for some s εΣ*, we know that if e.g. P(Σ|s)=P(Σ| suff(s)), then predicting the next symbol using s will produce exactly the same results as using its shorter version given in suff(s). Thus, in this case it is clear that keeping only suff(s) in the model should suffice for the prediction. The main goal of this algorithm is exactly to preserve only the suffixes necessary for this prediction. The parameters in our model obviously correspond to P(σ|s,c)∀σε Σ, ∀s εΣ*, ∀c ε C, and we use the training data to estimate these parameters.

As done in [14], we wish to construct a suffix tree \hat{T} that will include all the relevant suffixes. In this tree, the root node correspond to the empty suffix, the nodes in the first level correspond to suffixes of order one, s₁εΣ¹, and so forth. In the original work describing the VMM model, the process of building the model consisted of two steps (see [14] for details). First, only suffixes sεΣ* for which the empirical probability in the training data, \hat{P}(s), was non negligible, were kept in the model. Thus, suffixes for which there is not enough statistics for estimating \hat{P}(Σ|s) are ignored. In the second step all suffixes that are not necessary for predicting the next symbol are pruned out of the model. Specifically, this is done by considering

D_{KL}[\hat{P}(Σ|s)∥\hat{P}(Σ|suff(s))] (4)

where D_{KL}[p∥q]=Σₚp log

$${D}_{KL} [ p ‖ q ] = {\sum }_{p}^{} p log \frac{p}{q}$$

is the familiar Kulback-Libeler divergence [7].

\hat{P}(Σ|s) is naturally estimated by,

$$\hat{P} ( σ \vert s ) = \frac{n ( σ \vert s )}{{\sum }_{{σ}^{′} ∈ Σ}^{} n ( {σ}^{′} \vert s )} ∀ σ ∈ Σ \qquad ( 5 )$$

where n(σ|s) is the number of occurrences of the symbol σ right after s in the training data.

Estimating \hat{P}(σ|s,c) is done in a similar way, using only the training data given for the category c. If \hat{P}(σ|s)≈\hat{P}(σ| suff(s)), then predicting the next symbol using suff(s) will produce similar results as using s. In this case the corresponding D_{KL} will be relatively small and s will be pruned out of the model.

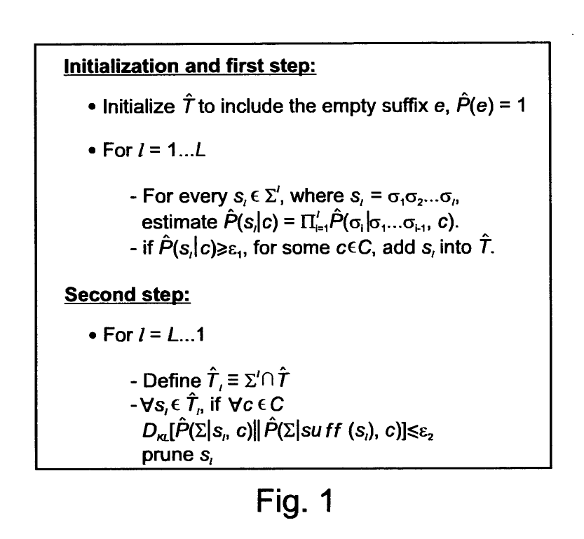

The above scheme is suited for building a model for a single statistical source. However, in the context of classification, we encounter more than one category. We therefore present a simple extension to the above procedure to deal with multiple classes. In the first step we include in \hat{T} all subsequences which have non negligible statistics in at least one category. In the second step we prune all the subsequences that have a shorter suffix with similar predictions. Specifically, we prunes if D_{KL}[\hat{P}(Σ|s,c)∥\hat{P}(Σ| suff(s),c)] is relatively small for all cεC. We will refer to this algorithm as GVMM. A pseudo-code describing it is given in FIG. 1. Note that the resulting tree is exactly the conjunction of all the |C| trees that can be produced by building one generative model per category. We can now use this model to estimate P(d|c) by

$$\hat{P} ( d \vert c ) = {\prod }_{i = 1}^{\vert d \vert} \hat{P} ( {σ}_{i} \vert {s}_{i} , c ) ∀ c ∈ C , \qquad ( 6 )$$

where sᵢ correspond to the longest suffix of {σ₁ σ₂, . . . σᵢ₋₁} left in the model.

Multiclass Discriminative VMM Model

There are two potential drawbacks in the above procedure. First, the pruning scheme is rather conservative. Subsequences with similar prediction as their suffixes, in all the categories, are usually not too common. Second, while building the model we are essentially considering every category by itself, without taking into account possible interactions among them. As a simple example, assume that for some suffix s, \hat{P}(Σ|s,c)=\hat{P}(Σ|s)∀cεC, i.e. the current symbol and the category are independent given s. Clearly, every occurrence of s in a new sample d, will contribute exactly the same term for every c while estimating \hat{P}(d|c) (Eq. (6)). Since we are only interested in the relative order of the probabilities \hat{P}(c|d), these terms might as well be neglected (just like we neglected p(d) in Eq.(2)). In other words, preserving s in our model will have no contribution to the classification task, since this suffix has no discriminative power w.r.t. the given categories.

We now turn to give this intuition a more formal definition. In general, two random variables X and Y are independent iff the mutual information between them is zero. The definition of mutual information is given by (e.g. [7]),

$$I ( X ; Y ) = {\sum }_{x ∈ X}^{} p ( x ) {\sum }_{y ∈ Y}^{} p ( y \vert x ) log \frac{p ( y \vert x )}{p ( y )} , \qquad ( 7 )$$

where in our context we are interested in the following conditional mutual information,

$${I}_{s} ≡ I ( Σ ; C \vert s ) = {\sum }_{c ∈ C}^{} \hat{P} ( c \vert s ) {\sum }_{σ ∈ Σ}^{} \hat{P} ( σ \vert s , c ) log \frac{\hat{P} ( σ \vert s , c )}{\hat{P} ( σ \vert s )} \qquad ( 8 )$$

The estimation of \hat{P}(c|s) is done by Bayes formula, i.e.

$$\hat{P} ( c \vert s ) = \frac{\hat{P} ( s \vert c ) \hat{P} ( c )}{\hat{P} ( s )} ,$$

where for s=σ₁σ₂, . . . σ_{|s|} we get

$$\hat{P} ( c \vert s ) = {\prod }_{i = 1}^{\vert s \vert} \hat{P} ( {σ}_{i} \vert {σ}_{1} , … , {σ}_{i - 1} , c ) ,$$

and \hat{P}(s)=_{ΣcεC}\hat{P}(c) \hat{P}(s|c). The prior \hat{P}(c) can be estimated by the relative number of training samples labeled to the category c. As already mentioned, if Iₛ=0, s could certainly be pruned. Nevertheless, we may define a stronger pruning criterion, which considers also the suffix of s. Specifically, if Iₛ−I_{suff(s)}≦0 it seems natural to prune s and to settle for the shorter memory suff(s). The existence of this criterion means that suff(s) is effectively inducing more dependency between Σ and C than its extension s. Thus, preserving suff(s) in the model should suffice for the classification task. We can also look at the more general criterion Iₛ−I_{suff(s)}≦ε₂, where ε₂ is some threshold, not necessarily positive. Obviously, we can control the amount of pruning by changing ε₂.

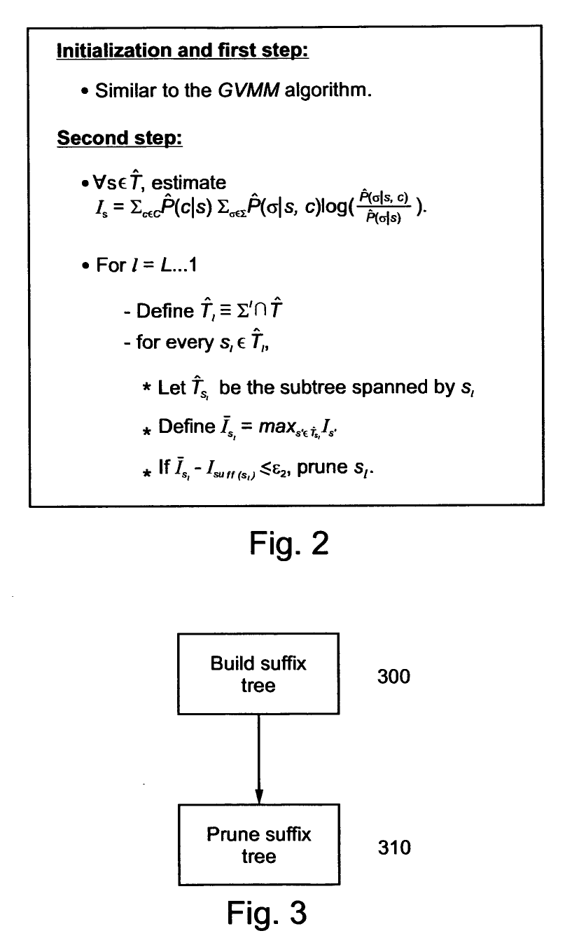

Lastly, we should notice that as in the original VMM work, the pruning criterion defined here is not associative. Thus, it is possible to get Iₛ₁>Iₛ₂<Iₛ₃ for s₃=suff(s₂)=suff(suff(s₁)). In this case we might prune the “middle” memory s₂ along with its son, s₁, though it might be that Iₛ₁>Iₛ₃. To avoid that we define the pruning criterion more carefully. We denote by \hat{T}ₛ the subtree spanned by s, i.e. all the nodes in \hat{T}ₛ, correspond to sub-sequences with the same suffix, s. We can now calculate \overline{I}ₛ=max_{s′ε\hat{T}}_{ₛ} I_{s′}, and define the pruning criterion by \overline{I}ₛ−I_{suff(s)}≦ε₂. Therefore, if there is no descendant of s (including s itself) that induces more information (up to ε₂) between Σ and C, w.r.t. s parent, suff(s), than we prune s along with all its descendants. We will refer to this algorithm as the DVMM algorithm. A pseudo-code is given in FIG. 2.

In the feature selection process, a known set of training data is analyzed in order to develop a model of the data which will be used by the system. In the present case the data consists of data sequences generated by two or more data sources. The source of each training set sequence is known. The goal is to determine subsequences that can be used to discriminate between sources generating new test sequences. Specifically, the probability that the presence of a subsequence within a test sequence is an indicator that the test sequence was generated by a given source is examined.

Reference is now made to FIG. 3, which shows a simplified flowchart of a preferred embodiment of a method for selecting a set of features from training data. The training data consists of a sequence of symbols, where each symbol is taken from an alphabet. In step 300, a suffix tree is built from the training data sequences. The suffix tree contains only sequences having an empirical probability of occurrence above a selected threshold, for at least one of the data sources. Sequences which occur infrequently are not included in the suffix tree. In step 310, the suffix tree is pruned of suffixes for which the suffix tree contains a shorter suffix with an equivalent predictive capability, for all data sources. Thus longer suffixes which are not necessary for predicting the next symbol are removed from the suffix tree.

The suffix tree may now be used for new test sequences, to determine which source the test sequence originated from. The suffix tree branches can discriminate between data sequence sources.

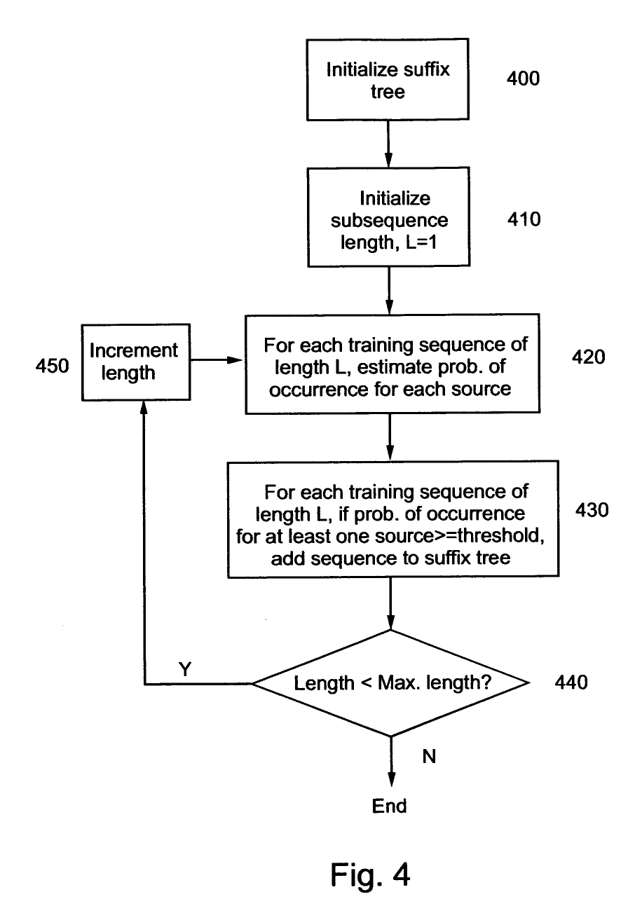

Reference is now made to FIG. 4, which shows a simplified flowchart of a preferred embodiment of a method for building a suffix tree. The resulting suffix tree contains all suffixes within the data training sequences which have a significant probability of occurrence, where the probability of occurrence is determined by the empirical probability of occurrence of the suffix within the training data. In step 400 the suffix tree is initialized to contain the empty suffix. In step 410 a suffix length, L, is initialized to one. The suffix length is incremented as the method progresses, until reaching the maximum suffix length being tested. In step 420, the empirical probability of occurrence is calculated for each suffix of length L in the training data, conditional upon each one of the data sources. The conditional probability of occurrence is calculated for each data source separately. Each suffix having a probability larger than a predetermine threshold, for at least one of the data sources, is added to the suffix tree in step 430. The sequence length, L, is compared to the maximum sequence length in step 440. If the length is less than the maximum length, the length is incremented in step 450, and a new iteration is begun at step 420. If the maximum length has been reached, the method terminates.

Once the suffix tree has been generated, suffixes which do not increase the predictive capacity of the suffix tree, in comparison with shorter suffixes within the tree, are removed from the tree. In the preferred embodiment, the relative predictive capability of suffixes is determined by examining the Kulback-Liebler divergence between the empirical probability of the alphabet used to generate the data sequences, conditional upon each of the suffixes. A shorter suffix is considered to have equivalent predictive capability as a longer suffix if the Kulback-Liebler divergence between the empirical probability given the longer suffix and the empirical probability given the shorter suffix is smaller than a predetermined threshold, for all of the data sources. The longer suffix may then be pruned from the suffix tree.

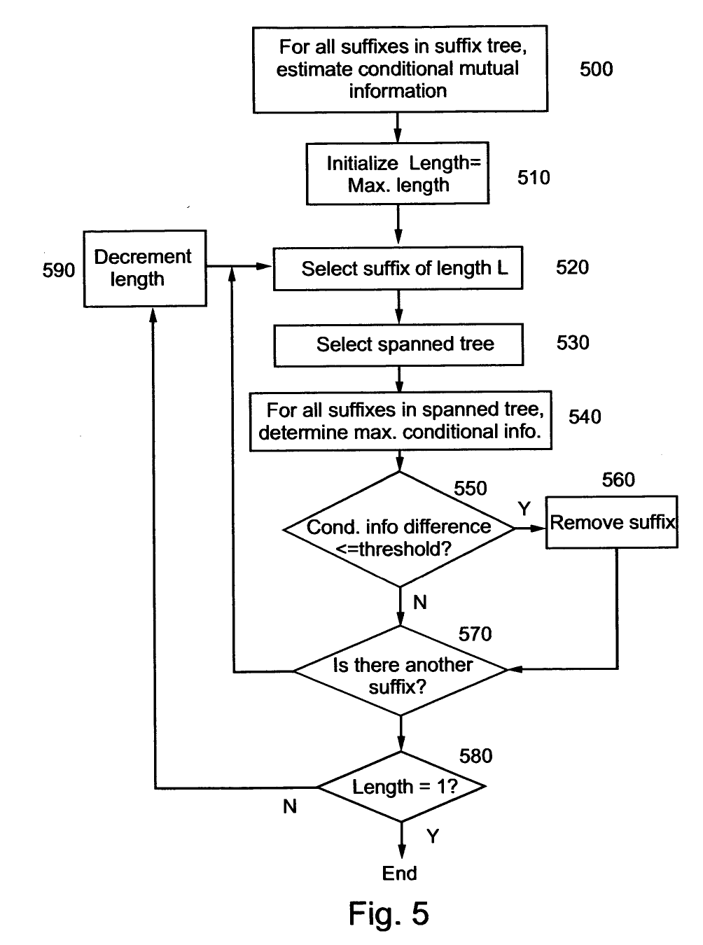

In an alternate preferred embodiment, a different criterion is used to determine which suffixes should be pruned from the suffix tree. Reference is now made to FIG. 5, which shows a simplified flowchart of a preferred embodiment of a method for pruning the suffix tree. In step 500, the condition mutual information between the alphabet and the data sources, given a suffix, is calculated for each suffix in the suffix tree. In step 510, the sequence length, L, is initialized to the maximum suffix length under consideration. All suffixes of length L in the tree are examined in tun, to determine which suffixes can be pruned from the tree. In step 520, a suffix of length L in the suffix tree is selected. Next, the sub-tree spanned by the selected suffix is selected in step 530. The conditional mutual information of each sequence within the spanned sub-tree is examined in step 540, and the suffix having the maximum conditional information is determined. In step 550 the difference between the conditional mutual information of the selected suffix and the maximum value is compared to a threshold. If the threshold is not reached, the selected suffix is pruned from the suffix tree in step 560. In step 570 the suffix tree is checked to determine if it contains another suffix of length L. If so, a new suffix is selected and checked (steps 520-570). When all suffixes of length L have been checked, the current length L is examined, in step 580. If the length is greater than 1, the length is decremented in step 570, and the algorithm continues as above for all suffixes of the new length. If a suffix length of 1 has been reached, the method terminates.

The above methods may be used to perform feature selection on various types of data sequences. In a preferred embodiment the data sequences are sequences of amino acids, and the data sources are protein families. The algorithm may be used to determine amino acid sequences that indicate that a protein is a member of a given protein family.

In an alternate preferred embodiment, the data sequences are sequences of nucleotides which may be used as indicators for transcription factors binding sites in a gene. In this case, the data sources are modeled as a positive data source, which generates nucleotide sequences which indicate binding sites within a gene, and a negative data source, which generates random sequences of nucleotides. In the preferred embodiment, the suffix tree is built and analyzed only for data sequences which indicate the positive source with a relatively high probability. The negative source is used only as a baseline reference. The resulting features are a set of short DNA sequences, which can be used to design and produce DNA chips. DNA arrays are used for tissue diagnosis and other purposes.

In another preferred embodiment, the data sequences are sequences of text characters, and the data sources are text datasets.

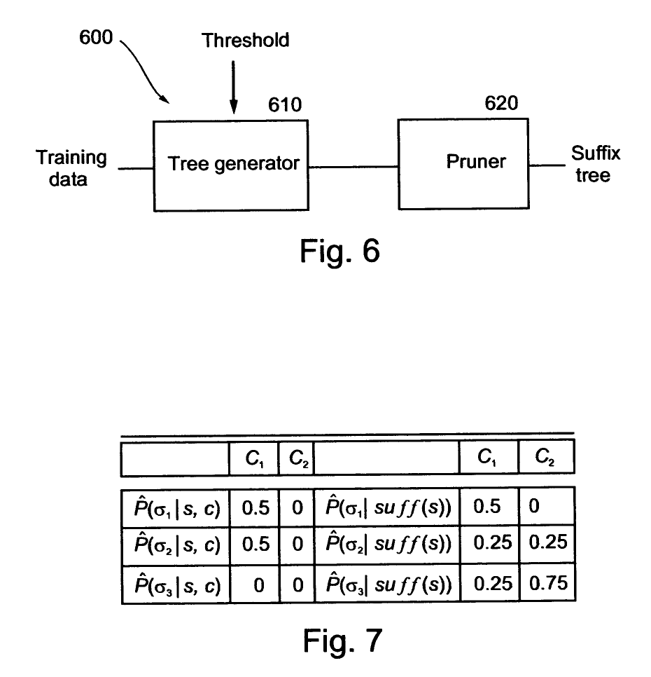

Reference is now made to FIG. 6, which is simplified a block diagram of a discriminative feature selector which selects a set of features from a set of training data sequences. The data sequences are generated from at least two data sources, and each data sequence consists of a sequence of data symbols taken from an alphabet. Feature selector 600 contains a tree generator 610 and pruner 620. Tree generator 610 builds a suffix tree from the training data, and pruner 620 prunes the suffix tree to remove suffixes that do not provide more predictive capability than a shorter suffix within the tree.

A Simple Example

In FIG. 7 we give a simple example to demonstrate the effect of pruning w.r.t. Iₛ. Apparently, the suffix s is an excellent feature for discriminating between c₁ and c₂, since it occurs only in the training samples labeled to c₁. Nevertheless, in this case (since \hat{P}(c₁|s)=1 and \hat{P}(c₂|s)=0), we will get Iₛ=0 and probably prune s out of the model. Though at first glance this seems wrong, in fact this pruning can be easily justified. Specifically, given s it is already “certain” that the category is c₁, thus supplying the current symbol σ can not add any additional information about the category identity, and accordingly Iₛ=0. However, while considering suff(s) we indeed see that the combination of this suffix and the current symbol, contains a lot of new information, not given in suff(s) by itself The pair suff(s)·σ₁ is a strong indicator that the category is c₁, while suff(s)·σ₃ is an indicator for C₂. Accordingly, I_{suff(s)} is relatively high, thus suff(s) will probably not be pruned. Note that while using the original pruning criterion, since \hat{P}(Σ|s,c₁) is relatively different from \hat{P}(Σ|suff(s),c₁), s would probably not be pruned, though from a classification point of view, it has no additional contribution over suff(s).

As another (extreme) example, one could imagine a case where all the suffixes of s (i.e. suff(s), suff(suff(s)) etc.) occurred only in c₁. In this case, all these suffixes will be pruned except for the empty suffix represented in the root of ·\hat{T}. Thus, there is one special symbol, σ*·, (the last symbol in s) which occurred only at c₁ and discriminate between the categories, and there is no need for preserving longer suffixes in our model. The combination of the empty suffix and σ* produces an optimal discriminant with a minimal memory depth. From all the suffixes of s, only the most compact one that preserve the maximal discrimination power, will be preserved.

Sorting the Remaining Features

Though the above procedure enable to produce a rather compact model for several statistical sources simultaneously, naturally not all the remaining features have the same discriminative power. As already explained, our feature set is effectively a Cartesian product of all the suffixes not pruned from \hat{T} with the alpha-bet Σ. Considering again the example in FIG. 3, clearly the pair suff(s)·σ₂ is less informative than the other two pairs, suff(s)·σ_{1,2}. This notion is represented through the fact that the contribution of the terms corresponding to σ₂ in calculating I_{suff(s)} is less significant than the contribution of the other terms. Therefore, we can define the following quantity for each feature,

$${I}_{σ \vert s} ≡ {\sum }_{c ∈ C}^{} \hat{P} ( c \vert s ) \hat{P} ( σ \vert s , c ) log ( \frac{\hat{P} ( σ \vert s , c )}{\hat{P} ( σ \vert s )} ) . \qquad ( 9 )$$

Thus, Iₛ=Σ_{σεΣ}I_{σ|s} and we can view I_{σ|s} as “the contribution of σ” to Iₛ. As before, if \hat{P}(σ|s,C)≈\hat{P}(σ|s), i.e. σ and C are almost independent given s, then I_{σ|s} will be relatively small, and vice versa.

This criterion can be applied for sorting all the features remained in our model. Yet, it might be that I_{σ1|s1}=I_{σ2|s2}, while \hat{P}(s₁)>>\hat{P}(s₂). Clearly in this case, one should prefer the first feature, {s₁·σ₁}, since the probability of encountering it in some new sample is much higher. Therefore, we should consider both factors, I_{σ|s} as well as \hat{P}(s) in our sorting procedure. Specifically, we give each feature a score defined by \hat{P}(s) I_{σ|s}, and sort all the features remained in the model by their scores

3.1 Maximize the Global Conditional Mutual Information

The pruning and sorting schemes defined above are based on the local conditional mutual information values given in Iₛ∀_{Sε}\hat{T}. However, in general we may consider the global conditional mutual information (see [7]), defined by

$$I ( Σ ; C \vert S ) = {\sum }_{s ∈ {Σ}^{*}} \hat{P} ( s ) I ( Σ ; C \vert s ) = {\sum }_{s ∈ {Σ}^{*}} \hat{P} ( s ) {I}_{s} , \qquad ( 10 )$$

where S is a random variable that its possible values are in the set Σ*.

Note that under the above definitions, the priors \hat{P}(s) are normalized separately for each level in the suffix tree, i.e. Σ_{sεΣ}_{¹}\hat{P}(s)=1 for every l. Thus for a full suffix tree \hat{T}, of maximal depth L, we should use the transformation

$$\hat{P} ( s ) -> \frac{\hat{P} ( s )}{L} \text{to guarantee that} {\sum }_{s ∈ \hat{T}} \hat{P} ( s ) = 1.$$

We can now view our algorithm as a method for finding a compact model that maximizes this information. In the first step, we neglect all suffixes with a relatively small prior \hat{P}(s). In the second step we prune all suffixes s for which Iₛ is small w.r.t. I_{suff(s)}. Lastly we sort all the remaining features by their contribution to this information, given by \hat{P}(s)I_{σ|s}. Translating this conditional mutual information into terms of conditional entropys, we get

(Σ;C|S)=H(C|S)−H(C|S,Σ) (11)

where H(C|S)=−Σₛ\hat{P}(s) Σ_{c}\hat{P}(c|s)log \hat{P}(c|s) is Shannon's conditional entropy (and H(C|S,Σ) defined similarly). Thus, assuming that the suffix s is already known, maximizing I(Σ;C|S) is equivalent to minimizing H(C|S,Σ). In other words, our model effectively tries to minimize the entropy, i.e. the uncertainty, over the category identity C, given the suffix S and the new symbol Σ.

Consider the formulation of the problem of locating binding sites mentioned above: The input is a set of sequences where most of the characters are picked at random, except for those of binding sites, which are conserved to some (possibly small) extent, and are repeated in some subset of the sequences. Thus, what differs upstream sequences from purely random ones, is that they contain binding sites. In other words, if we identify subsequences that differ upstream regions from random sequences, they are likely to be involved in binding regulatory elements. We do not think of these subsequences as binding sites, but as indicators for them—the “building blocks” from which they are built, or of some structural role that facilitates the binding.

This approach translates the problem to the context of feature selection. We consider the sequences of upstream regions as originating from one stochastic source (the “positive” source), denoted here by c₁, and sequences that were generated at random, as originating from some another (the “negative” source), denoted here by c₂. The object of feature selection is to find a set of features that optimally discriminate between these sources. However; there are two kinds of such features. Some features may serve as indicators for c₁. Given some new sequence, if these indicators appear in it, with high probability the stochastic source producing the sequence is c₁. In general, other features may likewise serve as indicators for c₂. In our context we are obviously interested only in features of the first kind, i.e. subsequences which are especially powerful indicators that a sequence is an upstream region. The question, of course, is, can we describe a well defined statistical framework for identifying these kinds of features.

Let Σ be the alphabet of the four nucleotide of which DNA sequences are composed, i.e. Σ≡{A,C,G,T}. The input to the algorithm is a set of labeled DNA sequences, some of them representing the “positive” source c₁, and the rest representing the “negative” source c₂.

In principle, we wish to construct a suffix tree \hat{T} that will include all the relevant suffixes for discriminating between the sources. In this tree, the root node corresponds to the empty suffix, the nodes in the first level correspond to suffixes of order one, s₁εΣ¹, and so forth. Note that the “negative” source c₂ is used only as a baseline reference, and in fact our main interest is in detecting strong indicators only for the “positive” source, c₁. Therefore, in the first step, we keep in the model only suffixes sεΣ* for which the empirical probability in c₁, \hat{P}(s|c₁) is non negligible. Specifically, for s=σ₁σ₂, . . . σ_{|s|} we define

$$\hat{P} ( s \vert {c}_{1} ) = {\prod }_{i = 1}^{\vert s \vert} \hat{P} ( {σ}_{i} \vert {σ}_{1} , … {σ}_{i - 1} , {c}_{1} ) .$$

The conditional probabilities \hat{P}(σ|sᵢ,c₁) are naturally estimated by,

$$\hat{P} ( σ \vert {s}_{i} , {c}_{1} ) = \frac{n ( σ \vert {s}_{i} , {c}_{1} )}{{\sum }_{{σ}^{′} ∈ Σ} n ( {σ}^{′} \vert {s}_{i} , {c}_{1} ) \vert} ∀ σ ∈ Σ \qquad ( 4 )$$

where n(σ|sᵢ,c₁) is the number of occurrences of the symbol σ right after sᵢ in the sequences representing the source c₁, and we use the notation sᵢ for σ₁ . . . σᵢ (estimating \hat{P}(σ|sᵢ,c₂) is done similarly, using the data given for c₂).

In the second step, all suffixes that do not yield features that discriminate well between the sources are pruned out of the model. We may consider the mutual information between the distribution of σ and that of the source c, conditioned on the appearance of the subsequence preceding that symbol, s. This conditional mutual information is given by (e.g. [20]),

$${I}_{s} ≡ I ( Σ ; C \vert s ) = {\sum }_{c ∈ C} \hat{P} ( c \vert s ) {\sum }_{σ ∈ Σ} \hat{P} ( σ \vert s , c ) log \frac{\hat{P} ( σ \vert s , c )}{\hat{P} ( σ \vert s )} \qquad ( 5 )$$

The estimation of \hat{P}(c|s) is done by Bayes formula, i.e.

$$\hat{P} ( c \vert s ) = \frac{\hat{P} ( c \vert s ) \hat{P} ( c )}{\hat{P} ( s )} , where \hat{P} ( s ) = {\sum }_{c ∈ C} \hat{P} ( c ) \hat{P} ( s \vert c )$$

and the prior \hat{P}(c) can be estimated by the relative number of training samples labeled to the category c. The probability of observing σ given s, unconditioned by the source, is of course given by \hat{P}(σ|s)=Σ_{cεC}\hat{P}(c|s)\hat{P}(σ|s,c). We will refer to this probability as the “joint” source probability.

However, there is a problem with using this exact measure for estimating the quality of a feature. Features which are strong indicators for the “negative” source might be considered as high quality features as well. To avoid that we consider only terms in Eq. (5) that correspond to the “positive” source, c₁, i.e.

$${I ( {c}_{1} )}_{s} ≡ \hat{P} ( {c}_{1} \vert s ) {\sum }_{σ ∈ Σ} \hat{P} ( σ \vert s , {c}_{1} ) log \frac{\hat{P} ( σ \vert s , {c}_{1} )}{\hat{P} ( σ \vert s )} \qquad ( 6 )$$

Note that the above expression is exactly the familiar Kulback-Libeler (KL) divergence [20] between P(σ|s,c₁) and the “joint” source probability (P(σ|s), multiplied by the prior factor P(c₁|s). Roughly speaking, the KL divergence measure how “different” the two probabilities \hat{P}(σ|s,c₁) and \hat{P}(σ|s) are. It is related to optimal hypothesis testing, when deciding if a sequence comes from c₁ or the “joint” source represented by P(σ|s) (e.g. [20]).

Note that by considering hypothesis testing between c₁ and the “joint” source, we bypass the problem of zero (empirical) probabilities. We define 0 log 0=0, and use the fact that \hat{P}(σ|s,c₁)>0→\hat{P}(σ|s)>0. If we consider hypothesis testing between c₁ and c₂ we must define how to deal with the case \hat{P}(σ|s,c₁)>0 while \hat{P}(σ|s,c₂)=0, which is very common in our data. Dealing with this situation is in general not a trivial issue.

This means that I(c₁)ₛ is high when the features corresponding to s are relatively good indicators for c₁ (i.e. for upstream sequences), and vice versa.

Therefore, we may now score each subsequence sε\hat{T} by I(c₁)ₛ. If I(c₁)ₛ<I(c₁)_{suff(s)}, it seems reasonable to prune s from the model. The existence of this criterion means that on the average, the features that correspond to suf(s) will provide better discrimination of c₁ from the joint source, than the features that correspond to s. We can also look at a more general criterion, I(c₁)ₛ−I(c₁)_{suf(s)}≦ε₂, where ε₂ is some threshold, not necessarily positive. Obviously, we can control the amount of pruning by changing ε₂.

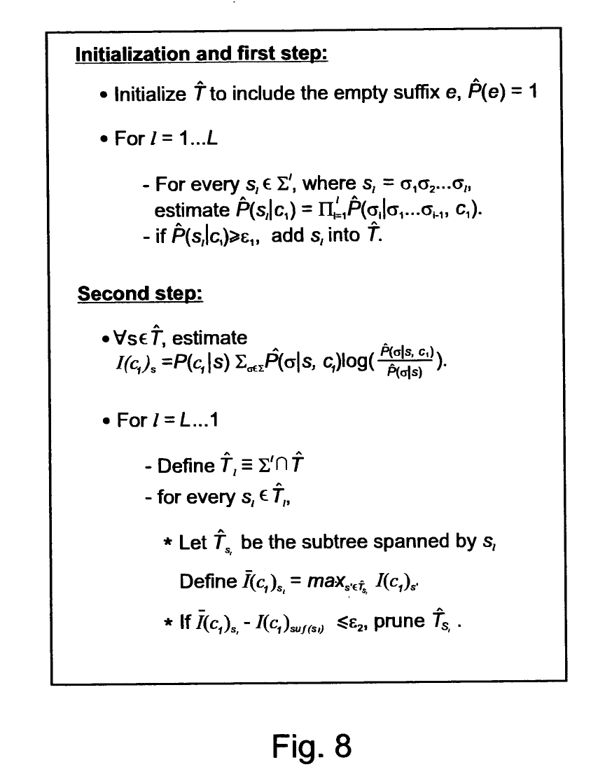

Lastly, we should notice that this pruning criterion is not associative. Thus it is possible to get I(c₁)ₛ₁>I(c₁)ₛ₂<I(c₁)ₛ₃ for s₃=suf(s₂)=suf(suf(s₁)). In this case we might prune the “middle” suffix s₂ along with its son, s₁, though it might be that I(c₁)ₛ₁>I(c₁)ₛ₃. To avoid that we define the pruning criterion more carefully. We denote by \hat{T}ₛ the subtree spanned by s, i.e. all the notes in \hat{T} that correspond to subsequences with the same suffix, s. We can now calculate \overline{I}(c₁)ₛ=max_{s′ε\hat{T}}_{ₛ}I(c₁)_{s′}, and define the pruning criterion by \overline{I}(c₁)ₛ−I(c₁)_{suf(s)}≦ε₂. A pseudo-code for this procedure is given in FIG. 8.

2.2 Sorting and Scoring

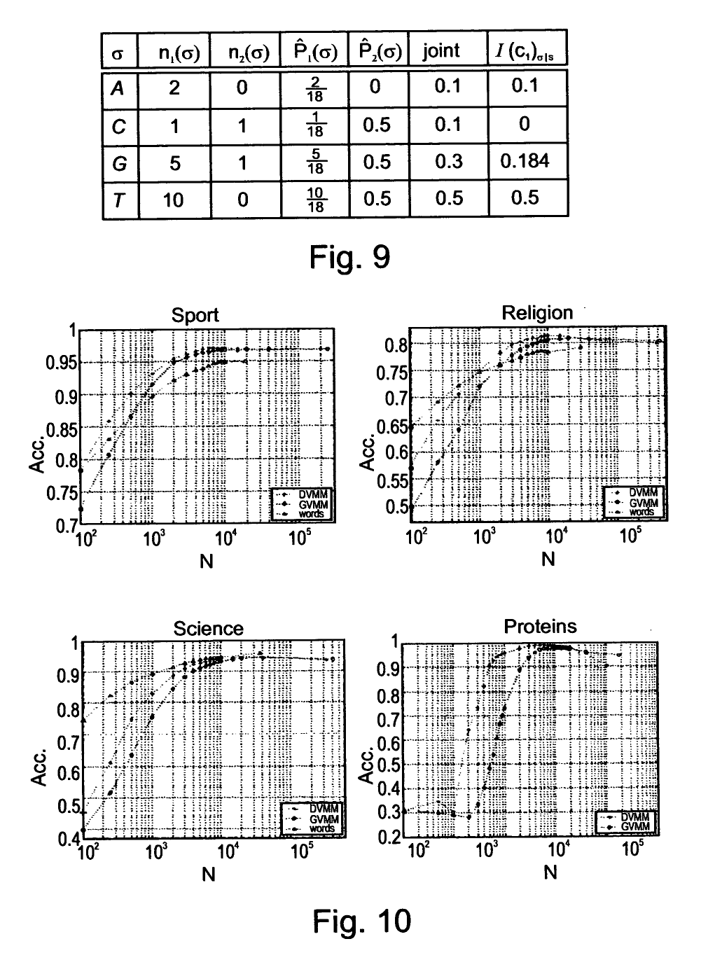

The above procedure produces a compact model which includes suffixes that induces high quality features for detecting c₁ w.r.t. c₂. Nevertheless, not all the remaining features have the same quality. Consider the example in FIG. 9. Clearly the feature s·C is less informative than the other pairs, s·A, G, T. Respectively, the contribution of the terms corresponding to C in calculating I(c₁)s is less significant than the contribution of the other terms. Therefore, we define the following quantity for each feature,

$${I ( {c}_{1} )}_{σ \vert s} ≡ \hat{P} ( {c}_{1} \vert s ) \hat{P} ( σ \vert s , {c}_{1} ) log ( \frac{\hat{P} ( σ \vert s , {c}_{1} )}{\hat{P} ( σ \vert s )} ) . \qquad ( 7 )$$

Thus, I(c₁)ₛ=Σ_{σεΣ}I(c₁)_{σ|s} and we view I(c₁)_{σ|s} as “the contribution of σ” to I(c₁)ₛ. As before, if \hat{P}(σ|s,c₁)≈\hat{P}(σ|s) then I(c₁)_{σ|s} will be relatively small, and vice versa. This criterion is thus applied for sorting all the features remained in our model. We can then mark the top N % features, and remove all the rest.

The remaining features are all strong indicators for a sequence to be an upstream region. Denote the set of these features F. All that remains is to use these features for specific predictions about binding sites locations, that is look for regions in the upstream sequence in which there is a high concentration of these features. Formally, for every position in the upstream sequence we find the longest corresponding feature in F, and give it a score of that feature. Doing this is straightforward. Let σ′ be the symbol at a position for which we want to calculate the score. Let s′ᵢ be the sequence of i characters that precede it. All the features s′ᵢσε F are plausible, we use the longest since it best describes what we see in the sequence. Denoting this longest suffix s′, the score for the position is I(c₁)_{σ′|s′} (Eq. (7)).

It might be that after keeping only the top N % features in the model, we will find no such feature. In this case, we simply score the current location by 0.

Notice that this score is “local”, i.e. it does not refer to the features that might be found before or after this specific location. However, since we view these features as indications for binding sites (rather than the binding sites themselves), we need some “smoothing” process that will score each location while taking into account its neighbors scores as well. To do this we define for each position in the sequence a frame of size 2*f+1, centered at it (including both the f positions preceding it, and the f positions succeeding it). The score of the frame is defined by the sum of the scores of all positions it covers.

Having done that we can now sort all the frames by their scores. The algorithm receives as an input parameter the number of symbols to mark as suspected to be binding sites. It then goes over the frames, from highest scoring to lowest, and marks all the positions within each frame as putative binding site characters, until the desired amount is marked, or no frame has a positive score

2.3 Algorithm Parameters

To summarize, the algorithm works as follows:

Grow the suffix tree.

Prune the suffix tree.

Sort the remaining features (leave only the top N %)

Calculate a score for each frame.

Mark the positions of top scoring frames.

Each of these steps include a potential parameter. While growing the suffix tree one should decide what probability is considered negligible, and thus the corresponding suffix in \hat{T} not be grown. This is formulated by comparing \hat{P}(s|c₁) to some threshold ε₁. Though in principle, if ε₁>0, there is no need to limit the maximal depth of \hat{T}, in practice it is usually simpler to set a limit. Thus, another parameter is L, the maximal depth of \hat{T}. In the pruning process we should also define some threshold ε₂ which controls the amount of pruning. After the sorting is done we need to define N that sets what percentage of the features we leave in the model. Additionally, the size of the frame 2*f+1, is another parameter of the algorithm.

Choosing the correct values for these parameters is obviously important, and in general, might be crucial for the algorithm to work properly. One could use a supervised learning framework to choose the proper values. That is, divide the upstream sequences into a training set and test set. The algorithm is run on the training set with various combinations of parameters' values, and the best combination is used for prediction on the test set. This process can be repeated several times for different partitioning of the data into training and test set (i.e. use cross-validation methods), to estimate how well it would perform “on average”.

Preliminary experiments in calibrating the parameters using this framework did not seem to yield a significant improvement. This might have to do with the dataset, which is perhaps too small for generalizing, or might simply require a better scheme for choosing the optimal parameters.

It is also unclear if the optimal parameters for one dataset (e.g. yeast DNA sequences) would remain the same for some other data set, coming from another organism, and, indeed, if and how biological knowledge can aid in setting them correctly.

Thus, and given the time consuming nature of cross validation tests, in this work we concentrate on a more simple approach We set every parameter to one, “reasonable” (though possibly arbitrary) value, chosen a priori, and use this value during all experiments. Our results show that this simple scheme can still yield high performance in many situations. We choose L=10, ε₂=0, N=10% and f=10. In the growing process, instead of using some ε₁ we just ignore all suffixes which did not appear at least twice in the given upstream sequences

### EXAMPLES

To test the validity of our method we perform several experiments over a variety of data types. In this section we describe the results for text and protein classification tests, and DNA sequence analysis.

4.1 Text Classification Tests

In all these experiments we set the alpha-bet Σ to be the set of characters present in the documents. Our pre-processing included lowering uppercase characters, and replacing digits and non alpha-numeric characters with two special symbols. This resulted with an alpha-bet containing 29 characters, including the blank character.

Obviously, this representation ignores the important role of the blank character as a separator between different words. Still, in many situations the “words” representation is not available, and all one knows is the basic alpha-bet (e.g. DNA bases, amino acids, etc.) Thus, for the purpose of demonstrating our method performance, we choose this low-level representation. We leave for future work to repeat the same tests, where we take Σ to be the set of words occurred in the texts.

4.1.1 Experimental Design

We used several datasets based on the 20Newsgroup corpus This corpus collected by Lang [11] contains about 20,000 documents evenly distributed among 20 UseNet discussion groups, and is usually employed for evaluating text classification techniques (e.g. [15]). We used 3 different subsets chosen from this corpus: the two newsgroups dealing with sport (rec.sport.baseball, rec.sport.hockey), the three newsgroups dealing with religion (alt.atheism, soc.religion.christian, talk.religion.misc), and the four science newsgroups (sci.crypt, sci.electronics, sci.med, sci.space). We will refer to these datasets as the SPORT, RELIGION and SCIENCE datasets respectively. For each dataset we ignored all file headers and randomly choose two thirds of the documents as the training set and used the remaining as the test set. We repeated this process 10 times and averaged the results. For each iteration, we build two models based on the training documents, using the GVMM and the DVMM algorithms. Given each model, for every test document d we estimated \hat{P}(C|d) and classify d into the most probable class. Specifically we used Eq. (6), where sᵢ correspond to the maximal suffix kept in our model and zero probabilities are smoothed by adding 10⁻⁷.

Additionally, in each model we sort all the remaining features by the scheme described in section 3. Thus we could check the performance using just the top N features (100≦N≦40,000), where in estimating \hat{P}(C|d) we ignore all occurrences of features which are not in the top N.

To gain some perspective, we also tested the classification accuracy while using the words representation, in a zero order Markov model (i.e. a “bag of words” representation). We used the same preprocessing for the characters and also ignored all words with only one occurrence. The remaining words (in the training set) were sorted by their contribution to the information about the category identity, i.e. by

$$I ( w ) = \hat{P} ( w ) {\sum }_{c ∈ C} \hat{P} ( c \vert w ) log \frac{\hat{P} ( c \vert w )}{\hat{P} ( c )} .$$

We used exactly the same Bayesian framework for the classification (see [16] for details). We emphasize that though in this representation one ignores the original order of the words (i.e. word context), there is massive empirical evidence for the high performance of this text classification scheme (e.g. [10]).

4.1.2 Text Classificaton Results

In FIG. 4 we present the (averaged) classification accuracy as a function of N (the number of selected features) for all three methods described above. For both VMM algorithms, during the first step we neglected all suffixes which appeared in less than 20 training documents. This is equivalent to neglecting suffixes with small \hat{P}(s). In the pruning step of DVMM we simply set ε₂ to zero. For GVMM we set ε₂ to be

$$\frac{1}{{n}_{s}} ,$$

where nₛ is the number of occurrences of the suffix s in the relevant category. For both algorithms we limited the maximal depth of \hat{T} to be 10. Note that a more careful tuning of these parameters might improve the classification performance.

In all three datasets, we clearly see the advantages of the new pruning criterion. Using this criterion we preserve a (smaller) feature set which seems to be better suited to the classification task. Thus though we use the same sorting procedure, the performance using a small subset of the features are significantly superior using the DVMM algorithm. For both algorithms we see that using only a small subset of the feature set, can yield the best classification performance. In two datasets, the DVMM performance are even superior to the performance using the words representation (for N≧2000).

4.2 Protein Classification Tests

The problem of automatically classifying proteins into biologically meaningful families, is becoming extremely important in the last few years. For this data, obviously there is no clear definition of “words”, and usually each protein is represented by its ordered sequence of amino acids. Therefore, the natural alphabet in this case consist of all the different amino acids, which induces 22 different basic symbols in Σ.

In a recent work, Bejerano and Yona suggested to approach protein classification using VMM models [4]. In that work, a generative VMM model was build for each family, such that it was possible to estimate the membership probability of new proteins for that family. Specifically it was shown that one may accurately identify when a protein is a member in that family or not. In the current work we check a similar application. However, we do not break the problem into |C| binary decision tasks. Instead, we directly address the problem of multi-class protein classification, i.e. given a set of protein families, we use the training set to build one VMM model to represent all families. New samples are classified using this model to their most probable family.

4.2.1 Experimental Design and Results

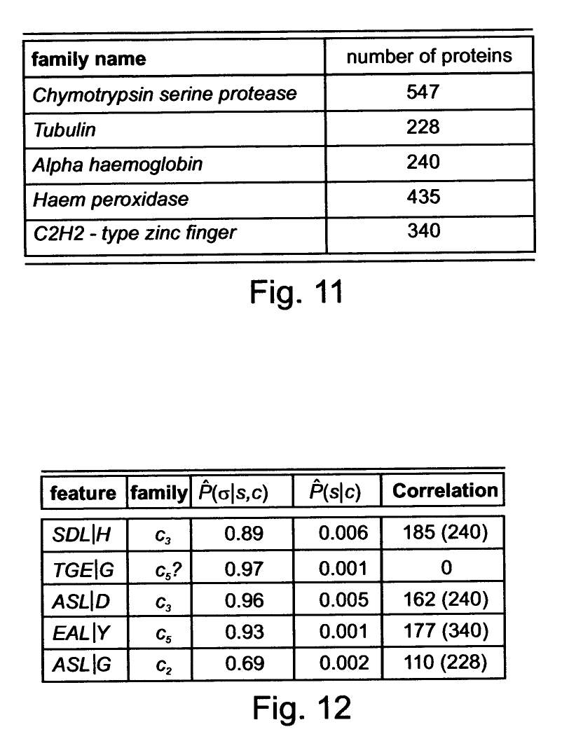

We used a subset of five protein families taken from the PRINTS-S database [2] (see FIG. 11 for the details). The experimental setting, including the parameters values, was exactly the same as for the text experiments (i.e. 10 random splits into training and test set etc.). The classification performance are presented in FIG. 10. Again, the optimal classification achieved using only a small subset of the features. The performance using the DVMM algorithm are clearly superier to the GVMM algorithm for small values of N.

Maybe even more interesting is to consider which features, i.e. amino acids sub-sequences, were sorted as the best discriminating features. In FIG. 12 we present the top 5 features w.r.t. all suffixes of length 3, for the DVMM algorithm (where we used all the data for this run). Four of them are highly correlated with sub-sequences that known in the literature as identifying some of these families (known protein motifs). One feature seems to have no correlation with known motifs, which raises the possibility to use this approach for detecting unknown protein motifs. Additionally, since the algorithm preserves only the shortest suffix necessary for discrimination, one could use it for identifying minimal subsequences that discriminate between protein families.

### COMPARATIVE EXAMPLES

In this section we describe our experiments and present a method for evaluating the performance of an algorithm, such as the one described above, that predicts specific locations for binding sites. The motivation is to provide the user with a clear and simple quantity that defines how well an algorithm is expected to work in practice. Essentially, we run the algorithm on sequences where (hopefully, most of) the binding sites locations are known, and check how often an algorithm's predictions are correct.

This evaluation is, of course, rather challenging. We are not looking for a consensus pattern, but rather to make concrete predictions on the DNA sequence directly. Not only that, it is reasonable to assume that our evaluation will be biased downwards, since typically not all the existing binding sites are known. As a result, when such an algorithm marks a position as belonging to a binding site, and that position is not part of any known binding site, one usually does not know whether this is indeed an error. Nevertheless, in the following we refer to all marks which are not part of a known binding site as an error (or “false positives”).

3.1 Data Used

For our study we used the fully sequenced genome of Saccharomyces Cerevisiae ([21]), and the Saccharomyces Cerevisiae Promoters Database (SCPD [35]). The latter contains a list of known transcription factors' binding sites, and their location in the Saccharomyces Cerevisiae genome We defined as upstream sequences all DNA sequences ending right before the translation start codon (ATG), and starting 600 bases before. In our preprocessing we removed all of the following entries from the SCPD data:

Entries where the binding site is on the complementary strand.

Entries where the binding site is not in the range of −600 to −1 upstream.

Entries that overlapped others (in this case we used the more recent publication).

Entries for Transcription Start Sites.

Entries that seemed inconsistent in the sense that their specified location did not match the sequence given for them.

This left 345 entries, giving the location for the binding sites in 176 upstream sequences. For each upstream sequence we defined a parallel random sequence, by randomly permuting the order of the symbols given in the original upstream sequence. Thus, our data includes 176 upstream sequences representing the “positive” source, c₁, and 176 “random” sequences representing the “negative” source c₂. Since almost all of the known binding sites in these upstream sequences are concentrated between −550 and −50 upstream we limited the algorithm's prediction (and evaluation) to this small region.

3.2 ROC Curve

A common tool for demonstrating how well an algorithm, such as the one we employ, performs, is an ROC curve. This curve describes the relative amount of correct predictions as a function of the relative amount of incorrect ones, or the tradeoff between “true positives” and “false positives”.

Formally, we call the characters that belong to known binding sites “positive”, and those that don't “negative”. We say that a character predicted by the algorithm to be part of a binding site is a “true positive” if it is indeed one, and “false positive” if it is not.

In a ROC one plots

$$\frac{number of true positives}{number of positive characters}$$

as a function of

$$\frac{number of false positives}{number of negative characters} .$$

If we mark, say α % of the data at random, we would expect to mark α % of the positive character and α % of the negative ones. Thus, no matter what α we choose, the ROC value would be on the y=x line.

On the other hand, had we known where the positive characters are, as long as we do not exhaust them, the ROC value would be on the line y=1.

In our setting, we expect that only part of the “positive” characters are actually known. Thus, if all the predictions are correct, but are made at random among the real “positive” characters, the ROC curve is expected to be along the y=β line, where, β is the portion of “positive” characters that are known.

We cannot expect our results to be this good, but we do hope that they will be well above the y=x line.

To estimate the significance of the results, one can use random simulation. That is, t characters in the upstream sequence are marked at random, the ROC value is calculated for them, and compared to what the algorithm achieves (while marking the same number of characters). The expected result is, of course, on the y=x, However, every now and then we do expect a result that greatly deviates from it. The random simulation thus gives us an estimate as to how significant an algorithm's results are—what is the probability (P-value) that better results are achieved at random.

3.3 Comparison with MatInspector

The ROC graph compares an algorithm's results to what is expected, had the prediction been done at random. As will be shown in the next section, it demonstrates that the algorithm suggested in this work is almost always performing significantly above random. However, another important question is how it performs in comparison with other algorithms.

As was discussed in the introduction, many of the currently purposed algorithms aim to answer a different question—that of finding a consensus pattern. Even if such a pattern is found, it is not obvious how well one can use this knowledge to actually locate the regulatory factors' binding sites in the genome sequence. The main tool currently in use for doing this is MatInspector ([27]), which receives as input a set of consensus matrices, and looks for subsequences along the genome that match them. The output of the program is a list of locations that match the consensus patterns, with two scores for each match—core similarity and matrix similarity.

For the comparison, we ran MatInspector on the sequences described above, with the consensus matrices provided with the program for fungi (many of which are annotated as belonging to yeast), and with the matrices given in SCPD. As in the test scheme mentioned above, we gave each position a score—the sum of the matrix similarity scores for matches which contained it. We then marked the top scoring positions as putative binding sites, and plotted the ROC curve for various values of t (where t is the number of characters marked by the algorithm). One should keep in mind that for MatInspector to work it must be provided with consensus matrices. These matrices are constructed in a supervised manner, relying on a-priori knowledge of enough examples for the type of binding sites searched for. In contrast, the algorithm suggested here looks for features in an unsupervised way and requires as input only the “raw” DNA upstream sequences.

Using the matrices provided by SCPD resulted in ROC lines that were close to random, perhaps because they tend to reflect much shorter consensus patterns, so we do not discuss them here. Also, we tested using the core similarity given by MatInspector, instead of the matrix similarity, and got poorer results, which we omit from this work. To summarize, we compare our unsupervised algorithm to the best results we could produce with MatInspector, which replies heavily on a-priori knowledge, constructed, in part, from the very data on which we make the tests (see the last section). Thus, this comparison is made to gain a perspective on the algorithm's performance, more than anything else.

3.4 Clustering by Gene Expression Patterns

To improve the chance of finding the rather weak “signal” of binding sites with DNA sequences, it would obviously be helpful if we could divide the sequences into sets containing similar binding sites. We do not have direct knowledge as to the proper division of the sequences, but we can use data from DNA microarrays to try and answer a closely related problem—identifying genes which are co-regulated. It is plausible that such genes are regulated by similar proteins, and therefore have similar binding sites in their upstream.

DNA microarray technology allows one to measure the amounts of transcribed mRNA in a cell, for each gene. Making these measurements over time, for example during the mitotic cell division ([31]), shows how a gene's expression behaves during the experiment. It is thought that genes with similar expression patterns are co-regulated.

Therefore, it is beneficial to first cluster the genes according to their expression patterns, and then use the prediction algorithm on each cluster. In this work we used data given in [22]—for each gene it lists the log ratio of the expression level during each experiment vs. the control. Thus, each gene is represented by a vector in space of dimension equal to the number of experiments, and we wish to cluster together positively correlated vectors. Specifically, we used clustering by Markovian relaxation and the information bottleneck method, recently suggested in [32]. The details of this clustering method are out of the scope of this work, we give here only a rough sketch.

The clustering algorithm requires as input a distance matrix between all elements to be clustered. We define the distance between every two genes by

$$d ( {g}_{i} , {g}_{j} ) = \frac{1 - {K}_{p} ( {g}_{i} , {g}_{j} )}{1 + {K}_{p} ( {g}_{i} , {g}_{j} )} ,$$

where Kₚ(gᵢ, gⱼ) is the Pearson correlation, (see, e.g., [22]) between the expression of genes gᵢ and gⱼ. The algorithm than transform this distance matrix into a transition probability matrix, and uses an agglomerative clustering procedure based on the information bottleneck method to find clusters of “similar” genes In FIG. 13 we present the distance matrix and sorted by the solution found by the algorithm for 6 clusters. We will refer to these 6 clusters as Clust1 . . . 6. In each of these clusters there is a similar behavior during the gene expression experiments (data not shown), which is expressed also through the fact that pairwise distances in each cluster are relatively small.

The gene expression data we used ([22]) refers only to 143 out of the 176 genes in the dataset. We also consider the remaining 33 genes as a cluster, denoted clust7, for which we have no reason to believe that the same proteins regulate transcription. In the next section we describe the performance of the algorithm on the entire dataset, and on each of the clusters separately.

4. Experimental Results

The algorithm bases its prediction on the score it calculates for each frame. We can think of this as a function over the positions of the upstream sequence, where the value of the function at a specific position is the score for the frame centered at it. As was discussed earlier, we expect that peak positions of this function will be correlated to binding site positions.

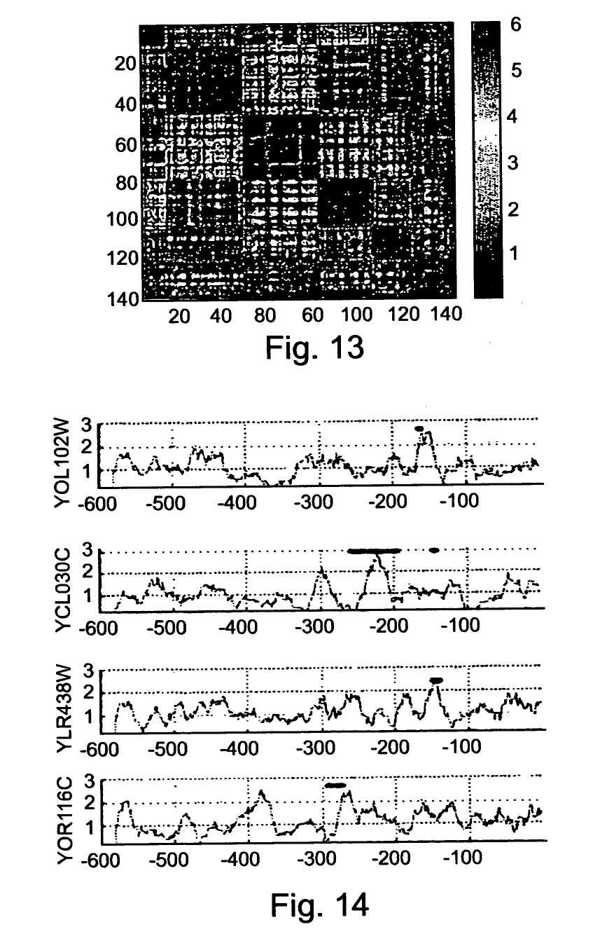

FIG. 14 compares the score function generated for four upstream sequences, those preceding the ORFs YDL102W (CDC2), YCL030C (HIS4), TLR438W (CAR2), YOR116C (RPO3 1). These are some of the sequences for which the algorithm performed well.

On the upstream of CDC2 there is one binding site listed, for the MCB binding factor, in positions −166 to −161. As can be seen in the figure, the scoring function achieves a distinct peak which intersects this position. The same is true for the upstream sequences of CAR2 and RPO31. In the latter, the peak that intersects the known binding site is around −280 upstream, and another peak is evident around −380 upstream. Given the task of locating new, unknown binding sites, the algorithm would predict such positions to be ones.

The upstream of HIS4 contains 4 binding sites, 3 of which are concentrated around the distinct peak of the function. Indeed, the complete SCPD dataset (before removing overlapping sites) lists 12 binding sites around this locations. As in the upstream of RPO31, another peak is evident, and would lead to a prediction in the corresponding position (−300).

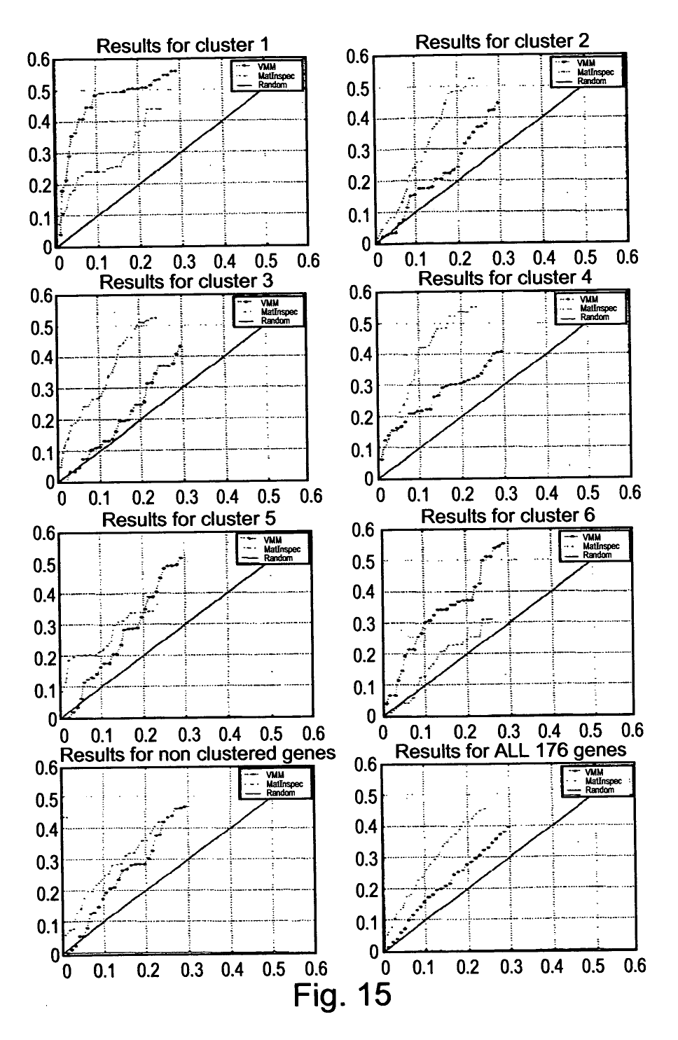

FIG. 15 describes the results achieved on each of the 6 clusters, generated from the gene expression data of [22], the 33 upstream sequences that did not appear in the data, and on the entire set of 176. The graphs show the line of an expected random performance (y=x, see section 3), the ROC curve for the algorithm presented here (VMM), and the best ROC curve we got with MatInspector. For the last two, we give the values when marking 1%-30% of the data, with increments of 1%. In all of these settings, the algorithm achieves results which are better than random, for almost the entire range.

In two of the clusters, namely cluster 1 and 6, the ROC curve is well above the random line, and is even better than that of MatInspector—often, the ratio of “true positives” for the algorithm is twice that of MatInspector. The worst results are for cluster 3, which is barely above the y=x line for most of the range. The results for the other clusters are somewhere in between, and are inferior to those of MatInspector. For the entire dataset, the ROC curve is above the y=x line, but it would seem that not enough to make the algorithm of practical use in this setting.

It is evident that there is a large variation in the ROC curve for each cluster, not only for our algorithm, but also for that of MatInspector.

Using random simulation, we estimated the p-values for each ROC point, in each of the clusters. We ran 100,000 simulations for each point, and counted the number of times the random simulation achieved a better ROC value than that of the algorithm. That is, in total, we ran 8×30×100,000=24,000,000 simulations.

As could be expected, for clusters 1, 4 and 6, for all points but one, none of the 100,000 simulations achieved a better results than that of our algorithm. Even for cluster 3, none of the simulations performed better than those of the algorithm for the last 9 percentiles, but most of the other values were not significantly above random. For the rest of the clusters, most of the points are significantly above random, and more often than not, none of the simulations achieved them. When testing the performance on all 176 genes, we actually ran only 10,000 simulations, because of the time requirements. For all points but the first one, none of the simulations was better than the actual results (p-value<1e-4). Note that we do not know all binding sites in our data, thus the “false positive” error is biased upwards.

It was shown that the algorithm generally performs significantly better than random, usually with p-value<1e-5. This in itself indicates that the technique which the algorithm realizes is promising, since a-priori we know that the “signal” of binding sites “hidden” in the upstream sequence is very weak. Dividing the upstream sequences of genes which are thought to be co-regulated, resulted in clusters on which the performance of the algorithm was very different, and generally better than on the entire dataset. It is not clear to us, at this point, why the performance varies so much. Superficial examination of the clusters did not reveal a correlation between how well the genes were clustered (measured by the average distance from the cluster's centroid) and the performance of the algorithm. However, looking for such correlations when only 6 clusters are involved, is bound to be misleading, and it is plausible that dividing the data into clusters of genes which are more closely co-regulated, will improve the results. We compared this unsupervised algorithm to the widely used MatInspector algorithm, which looks for pre-defined patterns in the sequences. Nevertheless, the results were often comparable, though n principle, supervised algorithms outperform unsupervised ones. Moreover. SCPD draws much of its data from TransFac ([34]), a general database for transcription factors. This very database is used for constructing the consensus matrices that MatInspector employs. Thus, in effect, our comparison tests MatInspector on data which is very close to its training set. We expect that its performance on such data will be very good, probably better than on sequences which contain binding sites for the same transcription factors, but ones which were not used in constructing the consensus patterns. Note also that algorithms such as MatInspector can only find new locations of known binding sites, while unsupervised algorithm can aim at locating those of unknown ones.

An obvious direction for improving the algorithm's performance was mentioned above. The algorithm is defined by several parameters, and rather than use arbitrary values for them, as we did here, it will probably be beneficial to construct a clever way of calibrating them. This could be based on biological knowledge, such as marking as binding sites a number of characters based on the typical distribution of binding sites number, length, and location.

We have seen that running the algorithm on sets of upstream sequences of co-regulated genes usually improves the performance. Calibrating the algorithm on each one, may result in different optimal parameter values for each cluster. This leads to the following work scheme. First cluster the genes for which binding sites are known into clusters of co-regulated genes. Then calibrate the parameters for each cluster and check that they are stable (e.g. by cross validation). Now, for genes that are regulated similarly to those in one of the clusters, and for which binding sites are not known, use the parameters tuned on their cluster for making the prediction. Alternatively, all the genes may be initially clustered, and the parameters calibrated afterwards.

A closer look should be given to the features which the algorithm extracts. Although we avoid looking for consensus patterns, it would be interesting to see whether the top scoring features share the same subsequences of known patterns. Also, the extracted features might have structural significance, such as the bending tendency or curvature of the DNA.

Likewise, structural considerations may be used for filtering out “false positives”. This is true in general, for every algorithm that makes such predictions—some locations on the DNA can not jointly bind transcription factors to create a functional complex. If such data is available, it can be incorporated to improve performance, by excluding such locations.

The main contribution of this work is in describing a well defined framework for learning variable memory Markov models, in the context of supervised classification tasks. The algorithm is efficient and could be applied for any kind of data (which exhibit Markov property), as long as a reasonable definition of a basic alpha-bet could be derived. The method advantages are especially emphasized for data types for which only the basic alpha-bet is known, and there is no natural definition for higher-level features. In these cases, the algorithm extracts features of variable length dependencies, that could serve directly for the classification task, and additionally yield important insights about the nature of the data.

In the DNA nucleotide sequence analysis embodiment, our goal is to provide a tool for the experimentalist to aid in the detection of binding sites. Such a tool should be easy to use, and should direct experimental design by providing putative binding sites locations. We presented an algorithm which is based on a well defined statistical frame work, is efficient, and in principle relies on DNA sequence alone.

An important application for an algorithm such as this one, is in supplementing Chromatin immunoprecipitation (ChIP, e.g. [23]) technology. This technology provides DNA sequences that are rich in binding sites. However, the location of the binding sites within the sequence is not known, and a method that can help in detecting them is essential.

Finally, the algorithm presented here can be used on organisms for which there is no detailed information, provided that some reasonable constraints on the relative location of binding sites is known. Also, since the algorithm is based on a general feature selection technique, it can be used for finding motifs in general, as was implicitly shown for proteins in [30]. For example, such motifs might be non-trivial sub-cellular localization signals, or protein (or RNA) structural features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

We claim:

1. A discriminative feature selection method for selecting a set of features from training data comprising a plurality of data sequences, said data sequences being generated from at least two data sources, and wherein each data sequence comprises a sequence of data symbols from an alphabet, said method comprising:
building a suffix tree from said training data, said suffix tree comprising suffixes of said data sequences having an empirical probability of occurrence from at least one of said sources greater than a first predetermined threshold; and
pruning from said suffix tree all suffixes for which there exists in said suffix tree a shorter suffix having equivalent predictive capability for all of said data sources.

2. A discriminative feature selection method according to claim 1, comprising using said suffix tree to determine a source of a test sequence.

3. A discriminative feature selection method according to claim 1, wherein building said suffix tree comprises:
initializing said tree to include an empty suffix;
initializing a subsequence length to one; and
for every data suffix of said length in said training data, performing a tree generation iteration comprising:
for every suffix of said length within said training data, and for each of said sources, estimating an empirical probability of occurrence of said suffix given said source;
if the empirical probability of occurrence of said suffix given one of said sources is not less than said first threshold, adding said suffix to said suffix tree;
if said length is less than a predetermined maximum length, incrementing said length by one and performing a further tree generation iteration; and
if said length equals a predetermined maximum length, discontinuing said suffix tree building process.

4. A discriminative feature selection method according to claim 1, wherein a shorter suffix has equivalent predictive capability as a longer suffix if a Kulback-Liebler divergence between an empirical probability of said alphabet given said longer suffix and an empirical probability of said alphabet given said shorter suffix is less than a second predetermined threshold, for all of said sources.

5. A discriminative feature selection method according to claim 1, wherein pruning said suffix tree comprises:
for all suffixes in said suffix tree estimating a conditional mutual information between said alphabet and said sources given said suffix;
setting a length equal to a predetermined maximum length; and
performing a pruning iteration, said iteration comprising the steps of:
for every suffix said length within said suffix tree, performing the steps of:
selecting a spanned-tree spanned by said suffix;
determining a maximum conditional information, comprising a maximum of conditional mutual information of all suffixes within said spanned-tree; and
if a difference between:
said maximum conditional information and a conditional information of a suffix shorter than said length within said spanned-tree is no greater than a second predetermined threshold, removing said suffix from said suffix tree;
if said length equals one, discontinuing said pruning process; and
if said length is greater than one, decrementing said length and performing a further pruning iteration.

6. A discriminative feature selection method according to claim 1, wherein said data sequences comprise sequences of amino acids, and wherein said data sources comprise protein families.

7. A discriminative feature selection method according to claim 1, wherein said data sequences comprise sequences of nucleotides, and said data sources comprise a positive data source generating nucleotide sequences which indicate binding sites within a gene, and a negative data source generating random sequences of nucleotides.

8. A discriminative feature selection method according to claim 7, wherein said suffix tree is built only for data sequences having a probability of occurrence from said positive source greater than said first predetermined threshold.

9. A discriminative feature selection method according to claim 1, wherein said data sequences comprise sequences of text characters, and wherein said data sources comprise text datasets.

10. A discriminative feature selector, for selecting a set of features from training data comprising a plurality of data sequences, said data sequences being generated from at least two data sources, and wherein each data sequence comprises a sequence of data symbols from an alphabet, the feature selector comprising:
a tree generator for building a suffix tree from said training data, said suffix tree comprising suffixes of said data sequences having a probability of occurrence from at least one of said sources greater than a first predetermined threshold; and
a pruner for pruning from said suffix tree all suffixes for which there exists in said suffix tree a shorter suffix having equivalent predictive capability.

11. A discriminative feature selector according to claim 10, further comprising a source determiner for using said suffix tree to determine a source of a test sequence.

12. A discriminative feature selector according to claim 10, wherein said data sequences comprise sequences of amino acids, and wherein said data sources comprise protein families.

13. A discriminative feature selector according to claim 10, wherein said data sequences comprise sequences of nucleotides, and said data source comprise a positive data source generating nucleotide sequences which indicate binding sites within a gene, and a negative data source generating random sequences of nucleotides.

14. A discriminative feature selector according to claim 13, wherein said suffix tree is built only for data sequences having a probability of occurrence from said positive source greater than said first predetermined threshold.

15. A discriminative feature selector according to claim 10, wherein said data sequences comprise sequences of text characters, and wherein said data sources comprise text datasets.
